(19) United States
(12) Patent Application Publication
(10) Pub. No.: US 2025/0155241 A1
(43) Pub. Date: May 15, 2025

(54) COMPARATIVE MEASURING TOOL AND MEASURING METHOD OF USING THE SAME

(71) Applicant: Guilin Gemred Sensor Technology Co., Ltd., Guilin (CN)

(72) Inventors: Bingheng LI, Guilin (CN); Guanglu YANG, Guilin (CN); Xiamei WEN, Guilin (CN); Mengying SHI, Guilin (CN)

(21) Appl. No.: 18/948,386

(22) Filed: Nov. 14, 2024

(30) Foreign Application Priority Data
Nov. 14, 2023 (CN) 202311514032.9

(51) Int. Cl. G01B 21/16

(52) U.S. Cl. CPC G01B 21/16; G01B 2210/46

(57) ABSTRACT

A comparative measuring tool, including: a storage unit; an input device; a measuring device; and a display device. The input device is configured to allow a user to perform function selection, deviation limit setting, and reference value adjustment; the measuring device is configured to capture a relative displacement and transmit the relative displacement to the storage unit; the display device comprises a display screen configured to show real-time data including the relative displacement, deviation limits, and a reference value.

### CROSS-REFERENCE TO RELATED APPLICATIONS

Pursuant to 35 U.S.C. § 119 and the Paris Convention Treaty, this application claims foreign priority to Chinese Patent Application No. 202311514032.9 filed Nov. 14, 2023, the contents of which, including any intervening amendments thereto, are incorporated herein by reference.

### BACKGROUND

The disclosure relates to the field of measuring tools, and more particularly, to a comparative measuring tool and a measuring method of using the same.

Comparative measuring tools are a type of instrument designed for relative measurement. When using one comparative measuring tool, the user first assembles a set of gauge blocks that match the reference dimensions of the object to be measured. After zeroing the comparative measuring tool with the set of gauge blocks, the set of gauge blocks are replaced with a work piece. The comparative measuring tool then displays the actual deviation from the reference dimensions.

To make the measurement process more efficient, the comparative measuring tools often have upper and lower deviation limits. The deviation limits allow the comparative measuring tool to automatically assess whether the measured deviation falls within an acceptable range, helping the user quickly determine if the work piece meets the required tolerances.

Currently, the deviation limits on the comparative measuring tools are set using two common methods. Method One: A deviation setting button is disposed among the functional operation keys of the comparative measuring tool. When the user enters the deviation setting mode, the displayed value is manually adjusted by incrementing or decrementing the number until the displayed value on the screen matches a desired deviation limit. The Method One is time-consuming, leading to user dissatisfaction due to its inefficiency and complexity. Method Two: The user enters the deviation setting mode via the deviation setting button. The comparative measuring tools is physically adjusted until the displayed value reaches the theoretical maximum or minimum deviation. Then the user confirms the deviation setting by pressing an appropriate button. The Method Two is easier to execute, but due to the fine resolution of the comparative measuring tool, it may be challenging for the user to stop the displayed value at a desired value.

### SUMMARY

To solve the aforesaid problems, the first objective of the disclosure provides a comparative measuring tool.

The comparative measuring tool comprises a storage unit, an input device, a measuring device, and a display device. The input device is configured to allow the user to perform operations such as function selection, deviation limit setting, and reference value adjustment. The measuring device is configured to capture a relative displacement and transmit the relative displacement to the storage unit. The display device comprises a display screen configured to show real-time data comprising the relative displacement, deviation limits, and reference value.

In a class of this embodiment, the measuring device comprises a sensor, a fixed jaw, and a movable jaw. The sensor is configured to detect the relative displacement between the fixed jaw and the movable jaw, and relay the relative displacement to the storage unit.

In a class of this embodiment, the measuring device is further configured to set measurement characters, such as the deviation limits and the reference value, and transmit the measurement characters to the storage unit.

The second objective of the disclosure is to provide a measuring method of using the comparative measuring tool, and the method comprises:
S1. combining a plurality of gauge blocks to match the reference value of an object to be measured;
S2. zeroing, using the plurality of gauge blocks, the comparative measuring tool; and
S3. setting a deviation range for the measured object; and beginning the comparative measurement process.

In a class of this embodiment, setting the deviation range comprises: entering the deviation setting mode by pressing a button on the input device; zeroing the comparative measuring tool at any position along a measurement range of the comparative measuring tool; moving the movable jaw, causing the displayed value to change in real-time; when reaching a desired value, confirming the deviation setting by pressing another button on the input device.

In a class of this embodiment, during setting the deviation range, the display screen refreshes in increments of 0.001 units.

In a class of this embodiment, the measurement characters are obtained as follows:
Integer part of the reference value: moving the movable jaw until the integer part of the displayed value matches a desired value; setting, using the measuring device, the integer part of the displayed value as the reference; and
Decimal part of the reference value and the deviation limits: detecting, using the sensor, the movement between the fixed jaw and the movable jaw; generating, using the sensor, pulse signals according to the detected movement; transmitting, using the sensor, the pulse signals to the storage unit; converting, using the storage unit, the pulse signals into the measurement characters; and transmitting, using the storage unit, the measurement characters to the display device.

The comparative measuring tool allows for real-time and fine adjustments, making it easier to set tolerances or deviation limits accurately. The comparative measuring tool takes the raw data from the sensor and maps the raw data to user-friendly numerical values. The mapping allows the user to interact directly with the comparative measuring tool through movement, rather than relying on button inputs. By reusing the existing sensor for data input, the comparative measuring tool provides enhanced functionality without increasing manufacturing costs.

### BRIEF DESCRIPTION OF THE DRAWINGS

FIG. 1 is a block diagram showing the composition of a comparative measuring tool according to one embodiment of the disclosure; and

FIG. 2 is a front view showing a display device of a comparative measuring tool according to one embodiment of the disclosure.

In the drawings, the following reference numbers are used: 1. Storage unit; 2. Input device; 3. Measuring device; 4. Display device; 5. Sensor; 6. Fixed jaw; and 7. Movable jaw.

### DETAILED DESCRIPTION

To further illustrate the disclosure, embodiments detailing a comparative measuring tool and a measuring method of using the same are described below. It should be noted that the following embodiments are intended to describe and not to limit the disclosure.

### Example 1

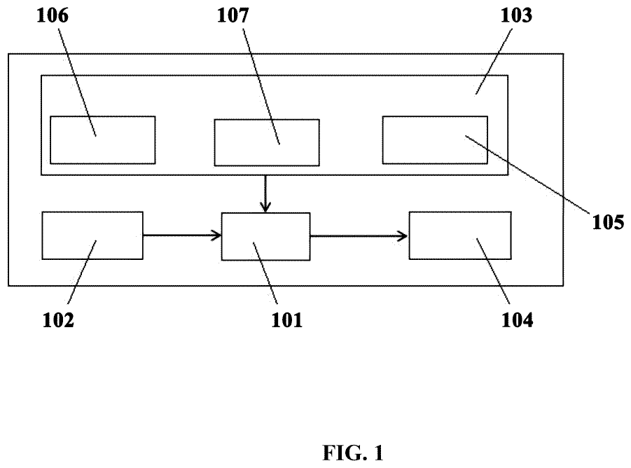

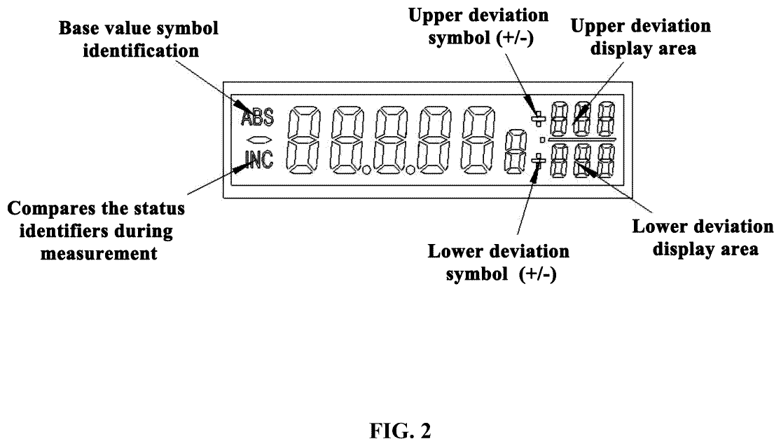

As shown in FIGS. 1 and 2, the disclosure provides a comparative measuring tool. The comparative measuring tool comprises a storage unit 1, an input device 2, a measuring device 3, a display device 4, a sensor 5, a fixed jaw 6, and a movable jaw 7.

In the example, the sensor detects the relative measurement between the movable jaw and the fixed jaw. The sensor then generates the raw measurement data representing continuous displacement. The continuous displacement is processed and mapped into input values through operations like scaling or calculating remainders. The input values are then used for adjusting deviation limits or other parameters.

In conventional measuring tools, such as digital calipers, sensors like grating sensors are typically used to measure the distances and generate signals. The signals are used to display the distances. Similarly, the encoding devices of the grating sensors are also employed in human-machine interface systems, such as knobs, for inputting data. By reusing the existing sensors for data input, the disclosure provides enhanced functionality without increasing manufacturing costs.

The input device is configured to allow the user to perform operations such as function selection, deviation limit setting, and reference value adjustment. The measuring device is configured to capture the relative displacement and transmit the relative displacement to the storage unit. The display device comprises a display screen configured to show real-time data comprising the distance measurements, the deviation limits, and the reference value.

The sensor is configured to detect the relative displacement between the fixed jaw and the movable jaw, and relay the relative displacement to the storage unit.

The measuring device is further configured to set measurement characters, such as the deviation limits and the reference value, and transmits the measurement characters to the storage unit.

### Example 2

A measuring method of using the comparative measuring tool comprises:
S1. combining a plurality of gauge blocks to match the reference value of an object to be measured;
S2. zeroing, using the plurality of gauge blocks, the comparative measuring tool; and
S3. setting a deviation range for the measured object; and beginning the comparative measurement process.

Setting the deviation range comprises: entering, by pressing a button on the input device, the deviation setting mode; zeroing the comparative measuring tool at any position along a measurement range of the comparative measuring tool; moving the movable jaw, causing the displayed value to change in real-time; when reaching a desired value, confirming the deviation setting by pressing another button on the input device.

During setting the deviation range, the display screen refreshes in increments of 0.001 units.

The measurement characters are obtained as follows:
acquiring integer part of the reference value: moving the movable jaw until the integer part of the displayed value matches a desired value; setting, using the measuring device, the integer part of the displayed value as the reference;
acquiring decimal part of the reference value and the deviation limits: detecting, using the sensor, the movement between the fixed jaw and the movable jaw; generating, using the sensor, pulse signals according to the detected movement; transmitting, using the sensor, the pulse signals to the storage unit; converting, using the storage unit, the pulse signals into the measurement characters; and transmitting, using the storage unit, the measurement characters to the display device.

For each movement that corresponds to a resolution point, the sensor generates n pulse signals. When the comparative measuring tool is in a character acquisition mode, every N pulse signals (where N>n) are counted as one unit in the displayed measurement value.

The comparative measuring tool comprises a memory function that retains the deviation limits and the reference value, even when the comparative measuring tool is powered off. When the comparative measuring tool is turned back on, the comparative measuring tool automatically displays the previously set deviation limits and reference value.

During setting the deviation range, for example, when the deviation is set to +0.056 mm, the user moves the movable jaw until the display shows 0.056 mm. At this point, the user confirms the deviation setting by pressing the button on the input device.

During counting every N pulse signals, for example, after counting N pulse signals, the display shows 0.001 mm. After 2N pulses, the display shows 0.002 mm. When the sensor counts K×N signals, the display shows K×0.001 mm.

Requiring N>n helps reduce the sensitivity of the comparative measuring tool during the counting process. The reduced sensitivity helps the user move the movable jaw more easily to find the correct deviation value.

In the deviation setting mode, the comparative measuring tool is first zeroed at any position along the measurement range of the comparative measuring tool. As the movable jaw is shifted before or after the zero point, the display screen displays positive or negative deviations, allowing the user to set both the upper and lower deviation limits.

When the deviation is set, the upper and lower deviation limits are displayed on the display screen. The display helps the user quickly assess whether the measured object is within the tolerance. If the measurement falls between the set deviation limits, indicating that the object meets the design requirements.

The reference value is established with the set of gauge blocks and showed directly on the display screen. With the reference value displayed, the user can quickly verify that the comparative measuring tool is correctly zeroed to the reference value.

A method for setting the reference value comprises setting the integer part and setting the decimal part. To set the integer part of the reference value, the user first moves the movable jaw until the displayed value's integer part aligns with that of the reference value. The alignment is then confirmed through the input device.

The decimal part of the reference value is set by following the same procedures as that used for setting the deviation limits.

During use, the input device allows the user to switch between different functions. When the display screen shows an “ABC” symbol, the symbol indicates that the current displayed value is the reference value. Conversely, when an “INC” symbol appears, the symbol signifies that the comparative measuring tool is displaying real-time measurement values.

It will be obvious to those skilled in the art that changes and modifications may be made, and therefore, the aim in the appended claims is to cover all such changes and modifications.

What is claimed is:

1. A comparative measuring tool, comprising:
a storage unit;
an input device;
a measuring device; and
a display device;
wherein:
the input device is configured to allow a user to perform function selection, deviation limit setting, and reference value adjustment; the measuring device is configured to capture a relative displacement and transmit the relative displacement to the storage unit; the display device comprises a display screen configured to show real-time data comprising the relative displacement, deviation limits, and a reference value.

2. The comparative measuring tool of claim 1, wherein the measuring device comprises a sensor, a fixed jaw, and a movable jaw; the sensor is configured to detect the relative displacement between the fixed jaw and the movable jaw, and relay the relative displacement to the storage unit.

3. The comparative measuring tool of claim 2, wherein the measuring device is further configured to set measurement characters, and transmit the measurement characters to the storage unit.

4. A measuring method of using the comparative measuring tool of claim 1, and the method comprising:
S1. combining a plurality of gauge blocks to match a reference value of an object to be measured;
S2. zeroing, using the plurality of gauge blocks, the comparative measuring tool; and
S3. setting a deviation range for the measured object; and beginning the comparative measurement process.

5. The method of claim 4, wherein setting the deviation range comprises:
entering a deviation setting mode by pressing a button on the input device;
zeroing the comparative measuring tool at any position along a measurement range of the comparative measuring tool; moving the movable jaw, causing the displayed value to change in real-time; when reaching a desired value, confirming the deviation setting by pressing another button on the input device.

6. The method of claim 5, wherein during setting the deviation range, the screen display refreshes in increments of 0.001 units.

7. The method of claim 6, wherein the measurement characters are obtained as follows:
acquiring integer part of the reference value: moving the movable jaw until the integer part of the displayed value matches a desired value; setting, using the measuring device, the integer part of the displayed value as the reference; and
acquiring decimal part of the reference value and the deviation limits: detecting, using the sensor, the movement between the fixed jaw and the movable jaw; generating, using the sensor, pulse signals according to the detected movement; transmitting, using the sensor, the pulse signals to the storage unit; converting, using the storage unit, the pulse signals into the measurement characters; and transmitting, using the storage unit, the measurement characters to the display device.
